(19) United States
(12) Patent Application Publication
(10) Pub. No.: US 2013/0091369 A1
(43) Pub. Date: Apr. 11, 2013

(54) POWER-SAVING INPUT DEVICE AND POWER-SAVING METHOD FOR SUCH INPUT DEVICE

(71) Applicant: Yu-Yen Shih, Taipei (TW)

(72) Inventor: Yu-Yen Shih, Taipei (TW)

(73) Assignee: Primax Electronics Ltd., Taipei (TW)

(21) Appl. No.: 13/479,059

(22) Filed: May 23, 2012

(30) Foreign Application Priority Data
Oct. 7, 2011 (TW) 100136612

(51) Int. Cl. G06F 1/32

(52) U.S. Cl. 713/323

(57) ABSTRACT

A power-saving method for an input device is provided. The power-saving method includes steps of: counting an idle time of the input device, judging whether an ambient luminance value in an environment of the input device is detected or not according to the idle time of the input device, and allowing the input device to enter a first shallow sleep mode or a deep sleep mode by judging whether the ambient luminance value is higher than or lower than a predetermined luminance value.

### FIELD OF THE INVENTION

The present invention relates to an input device, and more particularly to a power-saving wireless input device.

### BACKGROUND OF THE INVENTION

A common input device such as a mouse, a keyboard or a handwriting tablet is widely used to input signals to a computer system that is connected to the input device. In response to these signals, the computer system executes corresponding commands. Generally, the conventional input device is connected with the computer system through a physical connecting wire. As known, it is difficult to store and manage the connecting wire, and the installation position of the input device is restricted to the length of the connecting wire.

With increasing development of science and technology, the wireless transmission technology is gradually applied to various electronic devices, including the input devices. Since the wireless input device is in communication with the computer system according to the wireless transmission technology, the problems resulting from the connecting wire are solved. However, the use of the wireless input device may result in some drawbacks. For example, it is a challenge to supply electric power to the wireless input device. Generally, when the signal is transmitted from a wired input device to the computer system through the physical connecting wire, the electric power is transmitted from the computer system to the wired input device through the physical connecting wire. Consequently, the electric power is acquired by the wired input device. However, for maintaining normal operations of the wireless input device, a battery is essential. In other words, the power management system for the wireless input device is very important.

Hereinafter, the configurations and operations of the conventional input device will be illustrated with reference to FIGS. 1 and 2. FIG. 1 is a schematic top view illustrating the outward appearance of a conventional input device. FIG. 2 is a functional block diagram illustrating the conventional input device connected to a computer system. For example, the conventional input device 1 is a wireless keyboard. As shown in FIG. 1, the conventional input device 1 has a plurality of keys 10. These keys 10 are disposed within the input device 1 and partially exposed to the surface of the input device 1. When one or more keys 10 are depressed, a corresponding key signal (e.g. a symbol signal, a letter signal or a number signal) is generated. In FIG. 2, the conventional input device 1 and a computer host 2 are shown. In addition to these keys 10, the conventional input device 1 further comprises a controlling circuit 11, a wireless signal transmitter 12 and a wireless signal receiver 13. The controlling circuit 11 is connected with these keys 10 (not shown in FIG. 2) and the wireless signal transmitter 12. The controlling circuit 11 comprises a controlling unit 111 and an oscillator 112. The controlling unit 111 is used for receiving the key signal (e.g. the symbol signal, the letter signal or the number signal), recognizing the pressed key 10, and outputting the key signal. The oscillator 112 is connected with the controlling unit 111 for periodically issuing a clock signal Sc in every predetermined cycle. According to the clock signal Sc, the key signal is received by the controlling unit 111. The wireless signal transmitter 12 is connected with the controlling circuit 11 for outputting the key signal (e.g. the symbol signal, the letter signal or the number signal) in a wireless transmission manner. The wireless signal receiver 13 is connected with a computer host 2 for receiving the key signal (e.g. the symbol signal, the letter signal or the number signal) from the wireless signal transmitter 12. After the key signal (e.g. the symbol signal, the letter signal or the number signal) is received by the computer host 2, the computer host 2 executes a command corresponding to the key signal (e.g. the symbol signal, the letter signal or the number signal).

The conventional input device 1 is operated by a power-saving method. FIG. 3 is a flowchart illustrating a power-saving method for a conventional input device. The power-saving method comprises the following steps. Firstly, in the step S1, an idle time Td of the input device is counted. Then, the step S2 is performed to compare the idle time Td with a first predetermined time T1. If the idle time Td is greater than the first predetermined time T1, the input device enters a first shallow sleep mode. Then, the step S3 is performed to compare the idle time Td with a second predetermined time T2. If the idle time Td is greater than the second predetermined time T2, the input device enters a second shallow sleep mode. Then, the step S4 is performed to compare the idle time Td with a third predetermined time T3. If the idle time Td is greater than the third predetermined time T3, the input device enters a deep sleep mode (Step S5).

For performing the power-saving method, the first predetermined time T1, the second predetermined time T2 and the third predetermined time T3 are previously set and stored in the controlling unit 111. For example, the first predetermined time T1 is 180 seconds, the second predetermined time T2 is 150 seconds, and the third predetermined time T3 is 120 seconds. During normal operations of the input device 1, the predetermined cycle for periodically issuing the clock signal Sc by the oscillator 112 is equal to a first predetermined cycle P1. In a case that the input device 1 enters the first shallow sleep mode, the predetermined cycle for periodically issuing the clock signal Sc by the oscillator 112 is equal to a second predetermined cycle P2. In a case that the input device 1 enters the second shallow sleep mode, the predetermined cycle for periodically issuing the clock signal Sc by the oscillator 112 is equal to a third predetermined cycle P3. In a case that the input device 1 enters the deep sleep mode, the predetermined cycle for periodically issuing the clock signal Sc by the oscillator 112 is equal to a fourth predetermined cycle P4. For example, the first predetermined cycle P1 is 30 ms, the second predetermined cycle P2 is 40 ms, the third predetermined cycle P3 is 50 ms, and the fourth predetermined cycle P4 is 60 ms.

Please refer to FIGS. 1 and 2 again. During normal operations of the input device 1, the key signals (e.g. the symbol signals, the letter signals or the number signals) from the keys 10 are continuously received by the controlling unit 111. Meanwhile, the controlling unit 111 judges that the input device 1 is not idle. Once the input device 1 is idle, the idle time Td of the input device 1 is counted by the controlling unit 111 (see the step S1 in FIG. 3). Then, the idle time Td of the input device 1 is compared with the first predetermined time T1 (e.g. 180 seconds) by the controlling unit 111 (see the step S2 in FIG. 3). If the idle time Td of the input device 1 is greater than the first predetermined time T1, the input device 1 enters the first shallow sleep mode. Whereas, if the idle time Td of the input device 1 is not greater than the first predetermined time T1 and the input device 1 is triggered, the step S1 is repeatedly done.

After the input device 1 enters the first shallow sleep mode, if the input device 1 is still idle, the idle time Td of the input device 1 is re-counted by the controlling unit 111 (see the step S3 in FIG. 3). If the input device 1 is in the first shallow sleep mode and the idle time Td of the input device 1 is greater than the second predetermined time T2 (e.g. 150 seconds), the input device 1 enters the second shallow sleep mode. Whereas, if the idle time Td of the input device 1 is not greater than the second predetermined time T2 and the input device 1 is triggered, the step S1 is repeatedly done.

Similarly, after the input device 1 enters the second shallow sleep mode, if the input device 1 is still idle, the idle time Td of the input device 1 is re-counted by the controlling unit 111 (see the step S4 in FIG. 3). If the input device 1 is in the second shallow sleep mode and the idle time Td of the input device 1 is greater than the third predetermined time T3 (e.g. 120 seconds), the input device 1 enters the deep sleep mode (see the step S5 in FIG. 3). Whereas, if the idle time Td of the input device 1 is not greater than the third predetermined time T3 and the input device 1 is triggered, the step S1 is repeatedly done.

In accordance with the above conventional power-saving method, if the input device 1 is in the first shallow sleep mode, the predetermined cycle for periodically issuing the clock signal Sc by the oscillator 112 of the controlling circuit 11 is switched from the first predetermined cycle P1 (e.g. 30 ms) to the second predetermined cycle P2 (e.g. 40 ms). Similarly, if the input device 1 is in the second shallow sleep mode, the predetermined cycle for periodically issuing the clock signal Sc by the oscillator 112 is switched from the second predetermined cycle P2 (e.g. 40 ms) to the third predetermined cycle P3 (e.g. 50 ms). Similarly, if the input device 1 is in the deep sleep mode, the predetermined cycle for periodically issuing the clock signal Sc by the oscillator 112 is switched from the s third predetermined cycle P3 (e.g. 50 ms) to the fourth predetermined cycle P4 (e.g. 60 ms). That is, as the input device 1 approaches the deep sleep mode, the predetermined cycle for periodically issuing the clock signal Sc is prolonged and the power consumption level of the input device 1 is reduced. In such way, the power-saving purpose is achieved.

From the above discussions about the power-saving method of the input device 1, when the input device 1 is idle, the input device 1 will sequentially enter different sleep modes to implement the power-saving function. However, the power-saving method still has some drawbacks. For example, if the user wants to leave the computer host 2 and temporarily disable the input device 1, the user fails to allow the input device 1 to directly enter the most power-saving deep sleep mode. In other words, the input device 1 needs to sequentially enter the first shallow sleep mode, the second shallow sleep mode and the deep sleep mode. Since the input device 1 fails to directly enter the most power-saving mode by the conventional power-saving method according to the practical requirements, the power-saving efficacy is unsatisfied.

### SUMMARY OF THE INVENTION

The present invention provides a power-saving input device capable of directly entering the most power-saving mode according to the practical requirements.

The present invention provides a power-saving method for an input device for allowing the input device to directly enter the most power-saving mode according to the practical requirements.

In accordance with an aspect of the present invention, there is provided a power-saving input device. The power-saving input device includes a casing, a luminance sensor and a controlling circuit. The luminance sensor is disposed on a surface of the casing for detecting an ambient luminance value in an environment of the power-saving input device. The controlling circuit is connected with the luminance sensor and storing a first predetermined time and a predetermined luminance value. If the power-saving input device has been idle for a time period greater than the first predetermined time, the controlling circuit determines whether the power-saving input device enters a deep sleep mode or a first shallow sleep mode by comparing the ambient luminance value with the predetermined luminance value. Whereas, if the ambient luminance value is lower than the predetermined luminance value, the power-saving input device enters the deep sleep mode, wherein if the ambient luminance value is higher than the predetermined luminance value, the power-saving input device enters the first shallow sleep mode.

In an embodiment, after the power-saving input device enters the first shallow sleep mode, if the controlling circuit judges that the power-saving input device has been idle for a time period greater than the second predetermined time, the power-saving input device enters a second shallow sleep mode.

In an embodiment, after the power-saving input device enters the second shallow sleep mode, if the controlling circuit judges that the power-saving input device has been idle for a time period greater than the third predetermined time, the power-saving input device enters the deep sleep mode.

In an embodiment, if the power-saving input device is in the first shallow sleep mode, the controlling unit has a first power consumption level. If the power-saving input device is in the second shallow sleep mode, the controlling unit has a second power consumption level. If the power-saving input device is in the deep sleep mode, the controlling unit has a third power consumption level. The first power consumption level is higher than the second power consumption level, and the second power consumption level is higher than the third power consumption level.

In an embodiment, the controlling circuit includes a controlling unit and an oscillator. The controlling unit is used for storing the first predetermined time and the predetermined luminance value, judging whether the power-saving input device has been idle for a time period greater than the first predetermined time, and comparing the ambient luminance value with the predetermined luminance value. The oscillator is disposed within the casing and connected with the controlling unit. If the power-saving input device is not idle, the oscillator issues a clock signal in every predetermined cycle.

In an embodiment, if the power-saving input device is in the first shallow sleep mode, the predetermined cycle is switched to a first cycle. Whereas, if the power-saving input device is in the second shallow sleep mode, the predetermined cycle is switched to a second cycle. Whereas, if the power-saving input device is in the deep sleep mode, the predetermined cycle is switched to a third cycle. The third cycle is longer than the second cycle, and the second cycle is longer than the first cycle.

In an embodiment, the power-saving input device is a wireless keyboard, a wired keyboard, a wireless handwriting tablet or a wired handwriting tablet, the luminance sensor is a light sensor, and the controlling unit is a microprocessor.

In an embodiment, the power-saving input device further includes a displacement sensor, which is disposed within the power-saving input device and partially exposed outside the casing. The displacement sensor is connected with the controlling circuit for detecting a motion of the casing, thereby generating a displacement signal.

In an embodiment, the power-saving input device is a wireless mouse or a wired mouse, the luminance sensor is a light sensor, and the controlling unit is a microprocessor.

In accordance with another aspect of the present invention, there is provided a power-saving method for an input device. The power-saving method includes steps of counting an idle time of the input device, judging whether an ambient luminance value in an environment of the input device is detected or not according to the idle time of the input device, and allowing the input device to enter a first shallow sleep mode or a deep sleep mode by judging whether the ambient luminance value is higher than or lower than a predetermined luminance value. If the ambient luminance value is lower than the predetermined luminance value, the input device enters the deep sleep mode. Whereas, if the ambient luminance value is higher than the predetermined luminance value, the input device enters the first shallow sleep mode.

In an embodiment, if the idle time of the input device is greater than a first predetermined time, the ambient luminance value in the environment of the input device is detected. Wherein, if the idle time of the input device is smaller than the first predetermined time, the idle time of the input device is re-counted.

In an embodiment, after the input device enters the first shallow sleep mode, the power-saving method further includes steps of re-counting the idle time of the input device, and judging whether the input device enters a second shallow sleep mode by comparing the idle time of the input device with a second predetermined time.

In an embodiment, after the input device enters the first shallow sleep mode, if the idle time of the input device is greater than the second predetermined time, the input device enters the second shallow sleep mode. After the input device enters the first shallow sleep mode, if the idle time of the input device is smaller than the second predetermined time, the idle time of the input device is re-counted.

In an embodiment, after the input device enters the second shallow sleep mode, the power-saving method further includes steps of re-counting the idle time of the input device, and judging whether the input device enters a deep sleep mode by comparing the idle time of the input device with a third predetermined time.

In an embodiment, after the input device enters the second shallow sleep mode, if the idle time of the input device is greater than the third predetermined time, the input device enters the sleep mode. After the input device enters the second shallow sleep mode, if the idle time of the input device is smaller than the third predetermined time, the idle time of the input device is re-counted.

In an embodiment, before the step of counting the idle time of the input device, the power-saving method further includes a step of setting the predetermined luminance value. The step of setting the predetermined luminance value includes sub-steps of detecting the ambient luminance value, setting a luminance value lower than the ambient luminance value as the predetermined luminance value, and storing the predetermined luminance value.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outward appearance of a conventional input device;

FIG. 2 is a functional block diagram illustrating the conventional input device connected to a computer system;

FIG. 3 is a flowchart illustrating a power-saving method for a conventional input device;

FIG. 4 is a schematic cross-sectional view illustrating an input device according to an embodiment of the present invention;

FIG. 5 is a functional block diagram illustrating the input device connected to a computer system according to the present invention; and

FIGS. 6A and 6B illustrate a flowchart of a power-saving method for an input device according to an embodiment of the present invention. The following power-saving method comprises the following steps.

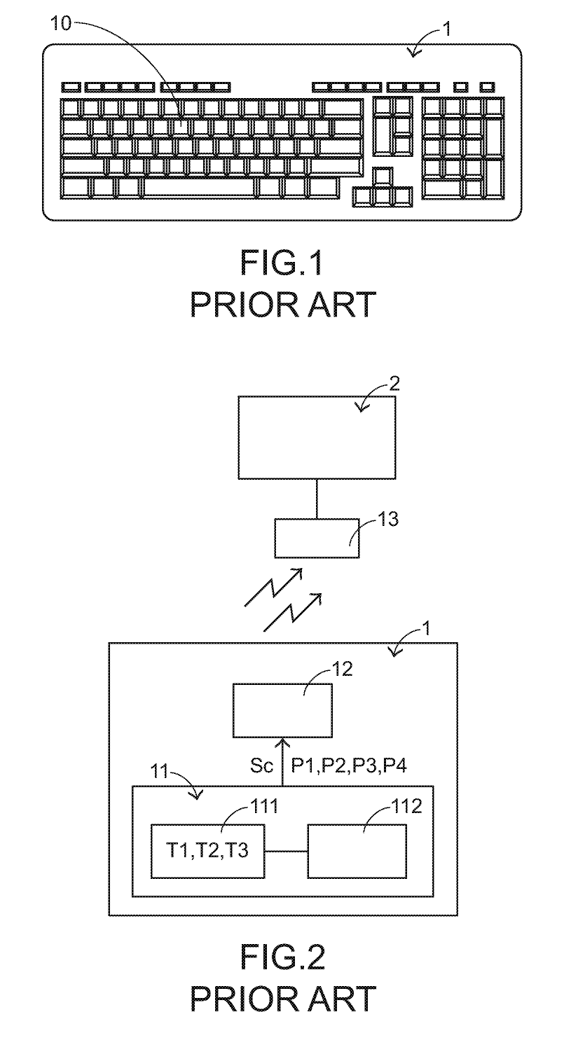

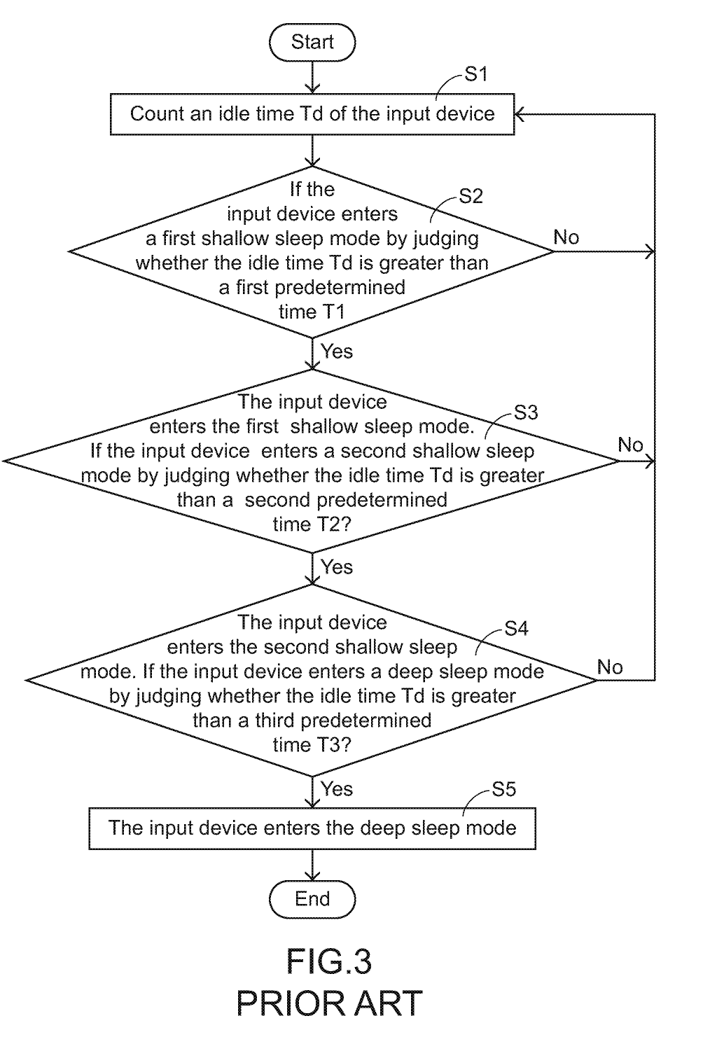

### DETAILED DESCRIPTION OF THE PREFERRED EMBODIMENT

For obviating the drawbacks encountered from the conventional power-saving method and the conventional input device, the present invention provides a power-saving input device and a power-saving method for the power-saving input device.

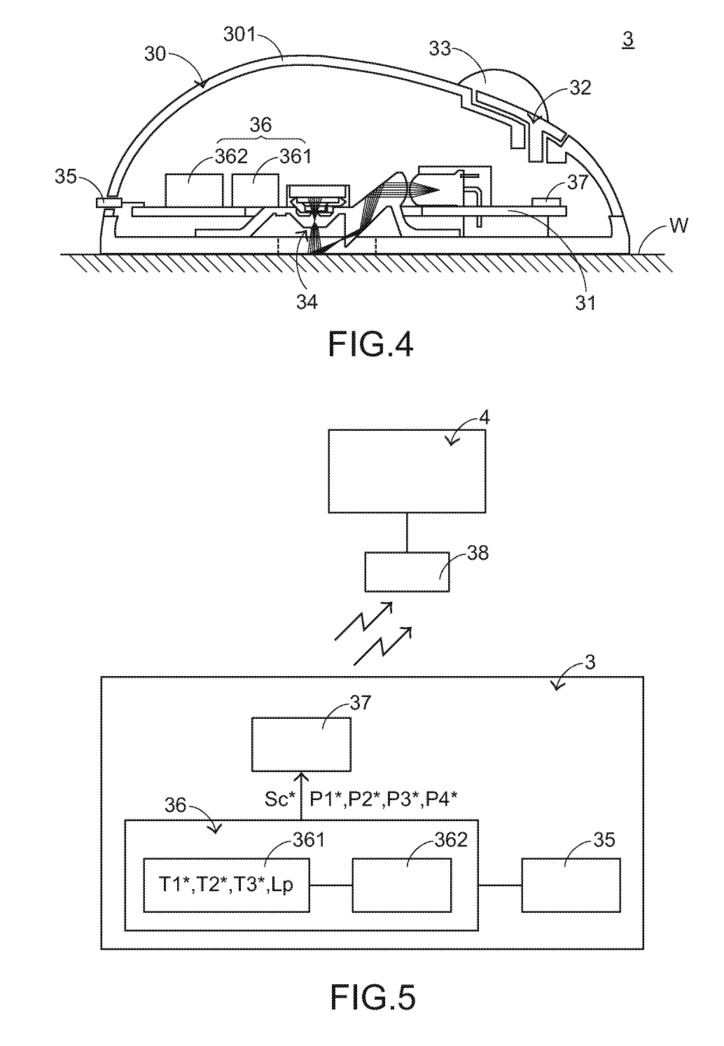

Please refer to FIGS. 4 and 5. FIG. 4 is a schematic cross-sectional view illustrating an input device according to an embodiment of the present invention. FIG. 5 is a functional block diagram illustrating the input device connected to a computer system according to the present invention. As shown in FIGS. 4 and 5, an input device 3 is placed on a working surface W. In this embodiment, the input device 3 is for example a wireless mouse. The input device 3 is in communication with a computer host 4. Moreover, the input device 3 comprises a casing 30, a circuit board 31, a first button 32, a second button (not shown), a wheel 33, a displacement sensor 34, a luminance sensor 35, a controlling circuit 36, a wireless signal transmitter 37, and a wireless signal receiver 38. The circuit board 31 is disposed within the casing 30. The displacement sensor 34, the luminance sensor 35 and the controlling circuit 36 are disposed on the circuit board 31. The first button 32, the second button and the wheel 33 are disposed on a surface 301 of the casing 30. When the first button 32, the second button and the wheel 33 are operated by a user, a corresponding button signal or wheel signal is generated. The displacement sensor 34 is disposed within the casing 30 and partially exposed outside the casing 30. Moreover, the displacement sensor 34 is connected with the controlling circuit 36 for detecting a motion of the casing 30 on the working surface W, thereby generating a corresponding displacement signal. The button signal, the wheel signal or the displacement signal is transmitted to the computer host 4. In response to the button signal, the wheel signal or the displacement signal, the computer host executes a corresponding command.

The luminance sensor 35 is disposed on the surface 301 of the casing 30, and connected with the controlling circuit 36 through the circuit board 31. The luminance sensor 35 is used for detecting an ambient luminance value Le in the environment of the input device 3. The controlling circuit 36 comprises a controlling unit 361 and an oscillator 362. The controlling unit 361 is disposed on the circuit board 31. In addition, a first predetermined time T1*, a second predetermined time T2*, a third predetermined time T3* and a predetermined luminance value Lp are previously set and stored in the controlling unit 361. The oscillator 362 is also disposed on the circuit board 31 and connected with the controlling unit 362 for periodically issuing a clock signal Sc* in every predetermined cycle. According to the clock signal Sc*, the key signal is received by the controlling unit 362. In this embodiment, the luminance sensor 35 is a light sensor, and the controlling unit 361 is a microprocessor. The configurations and functions of the wireless signal transmitter 37 and the wireless signal receiver 38 are well known in the art, and are not redundantly described herein.

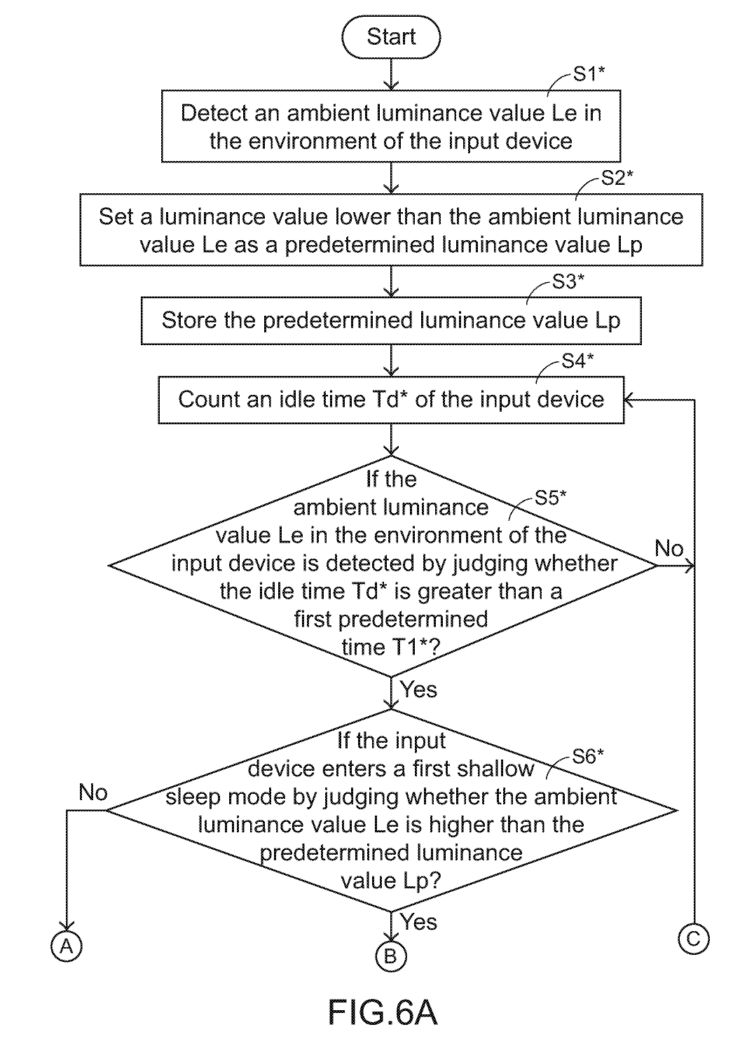

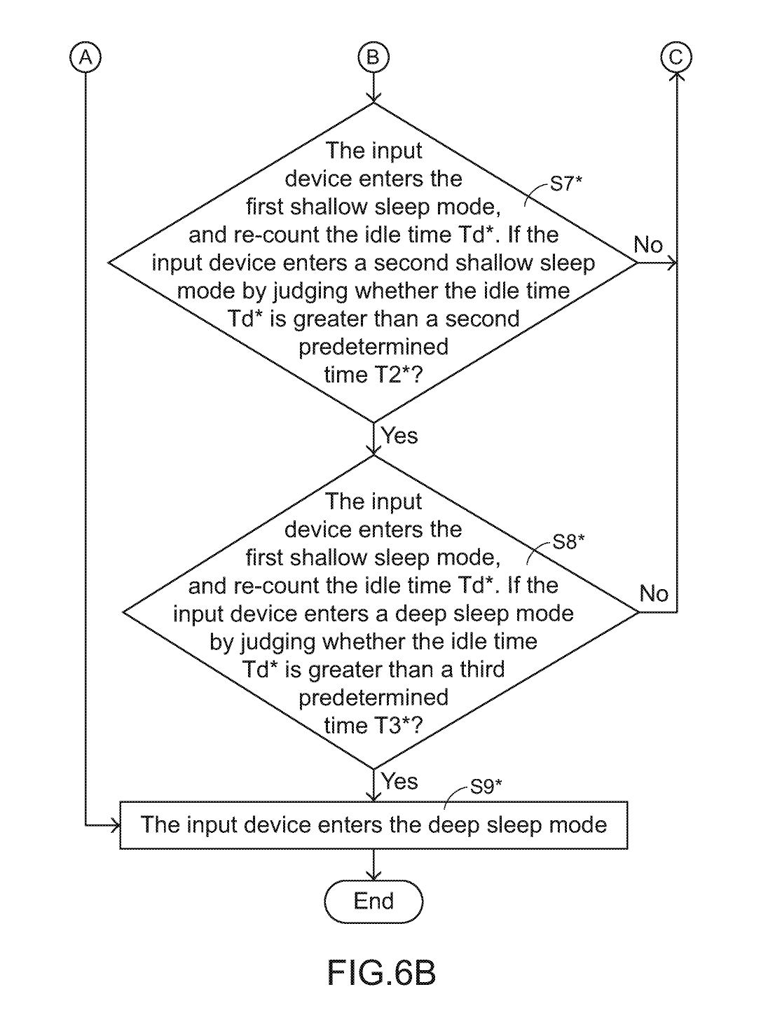

The present invention further provides a power-saving method for an input device. FIGS. 6A and 6B illustrate a flowchart of a power-saving method for an input device according to an embodiment of the present invention. The following power-saving method comprises the following steps. Firstly, in the step S1*, an ambient luminance value Le in the environment of the input device is detected. In the step S2*, a luminance value lower than the ambient luminance value Le is set as a predetermined luminance value Lp. In the step S3*, the predetermined luminance value Lp is stored.

In the step S4*, an idle time of the input device is counted. Then, the step S5* is performed to compare the idle time Td* with a first predetermined time T1*. If the idle time Td* is greater than the first predetermined time T1*, the ambient luminance value Le in the environment of the input device is detected. Then, the step S6* is performed to compare the ambient luminance value Le with the predetermined luminance value Lp. If the ambient luminance value Le is higher than the predetermined luminance value Lp, the input device enters a first shallow sleep mode. Whereas, if the ambient luminance value Le is not higher than the predetermined luminance value Lp, the input device enters a deep sleep mode (Step S9*). In the step S7*, the input device enters the first shallow sleep mode, and the idle time Td* is re-counted. The idle time Td* is compared with a second predetermined time T2*. If the idle time Td* is greater than the second predetermined time T2*, the input device enters a second shallow sleep mode. In the step S8*, the input device enters the second shallow sleep mode, and the idle time Td* is re-counted. The idle time Td* is compared with a third predetermined time T3*. If the idle time Td* is greater than the third predetermined time T3*, the input device enters the deep sleep mode (Step S9*).

In this embodiment, the first predetermined time T1*, the second predetermined time T2* and the third predetermined time T3* are previously set and stored in the controlling unit 361. For example, the first predetermined time T1* is 180 seconds, the second predetermined time T2* is 150 seconds, and the third predetermined time T3* is 120 seconds. Alternatively, in some other embodiments, the first predetermined time T1*, the second predetermined time T2* and the third predetermined time T3* are all equal (i.e. 120 seconds). Like the prior art technology, during normal operations of the input device 3, the predetermined cycle is equal to a first predetermined cycle P1*. In a case that the input device 3 enters the first shallow sleep mode, the predetermined cycle is equal to a second predetermined cycle P2*. In a case that the input device 3 enters the second shallow sleep mode, the predetermined cycle is equal to a third predetermined cycle P3*. In a case that the input device 3 enters the deep sleep mode, the predetermined cycle is equal to a fourth predetermined cycle P4*. For example, the first predetermined cycle P1* is 30 ms, the second predetermined cycle P2* is 40 ms, the third predetermined cycle P3* is 50 ms, and the fourth predetermined cycle P4* is 60 ms.

In this embodiment, the steps S1*-S3* are used to set the predetermined luminance value Lp before the input device is operated. In the step S1*, the ambient luminance value Le in the environment of the input device is detected by the luminance sensor 35 of the input device 3. Then, in the step S2*, a luminance value lower than the ambient luminance value Le is set as the predetermined luminance value Lp according to the practical requirements or the practical requirements. Afterwards, the predetermined luminance value Lp is stored in the controlling unit 361 (Step S3*). Meanwhile, the process of setting the predetermined luminance value Lp is completed.

Please refer to FIGS. 5 and 6 again. During normal operations of the input device 3, the button signals, the wheel signal and the displacement signal from the first button 32, the second button, the wheel 33 and the displacement sensor 34 are continuously received by the controlling unit 361. Meanwhile, the controlling unit 361 judges that the input device 3 is not idle. Once the input device 3 is idle, the idle time Td* of the input device 3 is counted by the controlling unit 361 (see the step S4* in FIG. 6). Then, the idle time Td* of the input device 3 is compared with the first predetermined time T1* by the controlling unit 111 (see the step S5* in FIG. 6). If the idle time Td* of the input device 3 is greater than the first predetermined time T1*, the ambient luminance value Le in the environment of the input device is detected by the luminance sensor 35 of the input device 3. Whereas, if the idle time Td* of the input device 3 is not greater than the first predetermined time T1* and the input device 3 is triggered, the step S4* is repeatedly done.

After the ambient luminance value Le in the environment of the input device is detected, the ambient luminance value Le is compared with the predetermined luminance value Lp by the controlling unit 361 (see the step S6* in FIG. 6). If the ambient luminance value Le is higher than the predetermined luminance value Lp, it means that the lighting device in the environment is not turned off and the input device 3 will be possibly operated by the user in a short time. Under thus circumstance, the input device 3 enters the first shallow sleep mode. Whereas, if the ambient luminance value Le is lower than the predetermined luminance value Lp, it means that the lighting device in the environment is turned off and the user does not want to operate the input device 3. Under thus circumstance, the input device 3 enters the deep sleep mode (see the step S9* in FIG. 6). After the input device 3 enters the first shallow sleep mode, the idle time Td* of the input device 3 is re-counted by the controlling unit 361 (see the step S7* in FIG. 6). If the input device 3 is in the first shallow sleep mode and the idle time Td* of the input device 3 is greater than the second predetermined time T2*, the input device 3 enters the second shallow sleep mode. Whereas, if the idle time Td* of the input device 3 is not greater than the second predetermined time T2* and the input device 3 is triggered, the step S4* is repeatedly done.

Similarly, after the input device 3 enters the second shallow sleep mode, the idle time Td* of the input device 3 is re-counted by the controlling unit 361 (see the step S8* in FIG. 6). If the input device 3 is in the second shallow sleep mode and the idle time Td* of the input device 3 is greater than the third predetermined time T3*, the input device 3 enters the deep sleep mode (see the step S9* in FIG. 6). Whereas, if the idle time Td* of the input device 3 is not greater than the third predetermined time T3* and the input device 3 is triggered, the step S4* is repeatedly done.

Hereinafter, two aspects of the present invention will be illustrated in more details. Firstly, if the input device 3 is in the first shallow sleep mode, the predetermined cycle for periodically issuing the clock signal Sc* by the oscillator 362 of the controlling circuit 36 is switched from the first predetermined cycle P1* (e.g. 30 ms) to the second predetermined cycle P2* (e.g. 40 ms). Since the predetermined cycle for periodically issuing the clock signal Sc* by the oscillator 362 is extended, the power consumption level of the input device 3 is reduced from a standard power consumption level to a first power consumption level. Similarly, if the input device 3 is in the second shallow sleep mode, the predetermined cycle for periodically issuing the clock signal Sc* by the oscillator 362 of the controlling circuit 36 is switched from the second predetermined cycle P2* to the third predetermined cycle P3* (e.g. 50 ms). Consequently, the power consumption level of the input device 3 is reduced to a second power consumption level. Similarly, if the input device 3 is in the deep sleep mode, the predetermined cycle for periodically issuing the clock signal Sc* by the oscillator 362 of the controlling circuit 36 is switched from the third predetermined cycle P3* to the fourth predetermined cycle P4* (e.g. 60 ms). Consequently, the power consumption level of the input device 3 is reduced to a third power consumption level. The standard power consumption level is higher than the first power consumption level, the first power consumption level is higher than the second power consumption level, and the second power consumption level is higher than the third power consumption level. That is, as the input device 3 approaches the deep sleep mode, the predetermined cycle for periodically issuing the clock signal Sc* is prolonged and the power consumption level of the input device 3 is reduced. In such way, the power-saving purpose is achieved.

Secondly, the controlling units perform two comparing steps, including the step of comparing the idle time Td* with the first predetermined time T1* and the step of comparing the ambient luminance value Le with the predetermined luminance value Lp. In some other embodiments, the settings of the controlling unit may be adjusted. For example, if the idle time of the input device is beyond (i.e. greater than or equal to) the first predetermined time, the ambient luminance value is detected; and if the idle time of the input device is smaller than the first predetermined time, the idle time of the input device is re-counted. Similarly, if the ambient luminance value is beyond (i.e. greater than or equal to) the predetermined luminance value, the input device enters the first shallow sleep mode; and if the ambient luminance value is lower than the first predetermined time, the input device enters the deep sleep mode. In other words, the settings of the controlling unit may be adjusted according to the practical requirements.

In the above embodiments, the power-saving input device is illustrated by referring to the wireless mouse. In some embodiments, another example of the power-saving input device of the present invention includes but is not limited a wired mouse, a wireless keyboard, a wired keyboard, a wireless handwriting tablet or a wired handwriting tablet. In a case that the power-saving input device is a wireless keyboard or a wireless handwriting tablet, the displacement sensor is not included in the wireless keyboard or the wireless handwriting tablet. The configurations and operating principles of other components are similar to those of the wireless mouse, and are not redundantly described herein. In a case that the power-saving input device is a wired mouse, a wired keyboard or a wired handwriting tablet, the wireless signal transmitter and the wireless signal receiver are replaced by a physical connecting wire. The operating principles thereof are similar to those of the wireless mouse, and are not redundantly described herein.

From the above description, the present invention provides a power-saving input device and a power-saving method for the input device. In a case that the power-saving input device is idle, the power-saving input device will enter the first shallow sleep mode or the deep sleep mode by comparing the ambient luminance value with the predetermined luminance value. That is, by detecting whether the lighting device in the environment is turned off or not, the power-saving method can judge whether the input device will be possibly operated by the user in a short time. Consequently, the input device is controlled to sequentially enter different sleep modes to achieve the power-saving purpose; or the input device is controlled to directly enter the deep sleep mode. According to the power-saving input device and a power-saving method, the input device may sequentially enter different sleep modes or directly enter the deep sleep mode. When compared with the prior art, the input device of the present invention is more power-saving.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power-saving input device, comprising:
a casing;
a luminance sensor disposed on a surface of said casing for detecting an ambient luminance value in an environment of said power-saving input device; and
a controlling circuit connected with said luminance sensor and storing a first predetermined time and a predetermined luminance value, wherein if said power-saving input device has been idle for a time period greater than said first predetermined time, said controlling circuit determines whether said power-saving input device enters a deep sleep mode or a first shallow sleep mode by comparing said ambient luminance value with said predetermined luminance value, wherein if said ambient luminance value is lower than said predetermined luminance value, said power-saving input device enters said deep sleep mode, wherein if said ambient luminance value is higher than said predetermined luminance value, said power-saving input device enters said first shallow sleep mode.

2. The power-saving input device according to claim 1, wherein after said power-saving input device enters said first shallow sleep mode, if said controlling circuit judges that said power-saving input device has been idle for a time period greater than said second predetermined time, said power-saving input device enters a second shallow sleep mode.

3. The power-saving input device according to claim 2, wherein after said power-saving input device enters said second shallow sleep mode, if said controlling circuit judges that said power-saving input device has been idle for a time period greater than said third predetermined time, said power-saving input device enters said deep sleep mode.

4. The power-saving input device according to claim 3, wherein if said power-saving input device is in said first shallow sleep mode, said controlling unit has a first power consumption level, wherein if said power-saving input device is in said second shallow sleep mode, said controlling unit has a second power consumption level, wherein if said power-saving input device is in said deep sleep mode, said controlling unit has a third power consumption level, wherein said first power consumption level is higher than said second power consumption level, and said second power consumption level is higher than said third power consumption level.

5. The power-saving input device according to claim 1, wherein said controlling circuit comprises:
a controlling unit for storing said first predetermined time and said predetermined luminance value, judging whether said power-saving input device has been idle for a time period greater than said first predetermined time, and comparing said ambient luminance value with said predetermined luminance value; and
an oscillator disposed within said casing and connected with said controlling unit, wherein if said power-saving input device is not idle, said oscillator issues a clock signal in every predetermined cycle.

6. The power-saving input device according to claim 5, wherein if said power-saving input device is in said first shallow sleep mode, said predetermined cycle is switched to a first cycle, wherein if said power-saving input device is in said second shallow sleep mode, said predetermined cycle is switched to a second cycle, wherein if said power-saving input device is in said deep sleep mode, said predetermined cycle is switched to a third cycle, wherein said third cycle is longer than said second cycle, and said second cycle is longer than said first cycle.

7. The power-saving input device according to claim 5, wherein said power-saving input device is a wireless keyboard, a wired keyboard, a wireless handwriting tablet or a wired handwriting tablet, said luminance sensor is a light sensor, and said controlling unit is a microprocessor.

8. The power-saving input device according to claim 5, further comprising a displacement sensor, which is disposed within said power-saving input device and partially exposed outside said casing, wherein said displacement sensor is connected with said controlling circuit for detecting a motion of said casing, thereby generating a displacement signal.

9. The power-saving input device according to claim 8, wherein said power-saving input device is a wireless mouse or a wired mouse, said luminance sensor is a light sensor, and said controlling unit is a microprocessor.

10. A power-saving method for an input device, said power-saving method comprising steps of:
counting an idle time of said input device;
judging whether an ambient luminance value in an environment of said input device is detected or not according to said idle time of said input device; and
allowing said input device to enter a first shallow sleep mode or a deep sleep mode by judging whether said ambient luminance value is higher than or lower than a predetermined luminance value, wherein if said ambient luminance value is lower than said predetermined luminance value, said input device enters said deep sleep mode, wherein if said ambient luminance value is higher than said predetermined luminance value, said input device enters said first shallow sleep mode.

11. The power-saving method according to claim 10, wherein if said idle time of said input device is greater than a first predetermined time, said ambient luminance value in said environment of said input device is detected, wherein if said idle time of said input device is smaller than said first predetermined time, said idle time of said input device is re-counted.

12. The power-saving method according to claim 10, wherein after said input device enters said first shallow sleep mode, said power-saving method further comprises steps of re-counting said idle time of said input device, and judging whether said input device enters a second shallow sleep mode by comparing said idle time of said input device with a second predetermined time.

13. The power-saving method according to claim 12, wherein after said input device enters said first shallow sleep mode, if said idle time of said input device is greater than said second predetermined time, said input device enters said second shallow sleep mode, wherein after said input device enters said first shallow sleep mode, if said idle time of said input device is smaller than said second predetermined time, said idle time of said input device is re-counted.

14. The power-saving method according to claim 12, wherein after said input device enters said second shallow sleep mode, said power-saving method further comprises steps of re-counting said idle time of said input device, and judging whether said input device enters a deep sleep mode by comparing said idle time of said input device with a third predetermined time.

15. The power-saving method according to claim 14, wherein after said input device enters said second shallow sleep mode, if said idle time of said input device is greater than said third predetermined time, said input device enters said sleep mode, wherein after said input device enters said second shallow sleep mode, if said idle time of said input device is smaller than said third predetermined time, said idle time of said input device is re-counted.

16. The power-saving method according to claim 10, wherein before said step of counting said idle time of said input device, said power-saving method further comprises a step of setting said predetermined luminance value, wherein said step of setting said predetermined luminance value comprises sub-steps of:
detecting said ambient luminance value;
setting a luminance value lower than said ambient luminance value as said predetermined luminance value; and
storing said predetermined luminance value.
